(19) United States
(12) Patent Application Publication
(10) Pub. No.: US 2015/0363100 A1
(43) Pub. Date: Dec. 17, 2015

(54) MOBILE ELECTRONIC DEVICE, CONTROL METHOD, AND STORAGE MEDIUM

(71) Applicant: KYOCERA Corporation, Kyoto-shi (JP)

(72) Inventors: Tsuneo MIYASHITA, Yokohama-shi (JP); Hiromi AJIMA, Kawasaki-shi (JP); Motoaki ABE, Yokohama-shi (JP); Yuka ISHIZUKA, Yokohama-shi (JP); Atsushi TAMEGAI, Daito-shi (JP); Hiroyuki BAMBA, Sagamihara-shi (JP)

(21) Appl. No.: 14/835,711

(22) Filed: Aug. 26, 2015

Related U.S. Application Data
(63) Continuation of application No. PCT/JP2014/054751, filed on Feb. 26, 2014.

(30) Foreign Application Priority Data
Feb. 27, 2013 (JP) 2013-037453

(51) Int. Cl. G06F 3/0484; G06F 3/0488

(52) U.S. Cl. CPC G06F 3/04847; G06F 3/0488

(57) ABSTRACT

In one aspect, when detecting an event such as receiving emails, missed calls, a schedule notification, or the like, a mobile electronic device executes a process for expanding a first operation part associated with the event on a display module and displaying a second operation part indicating a detail of the event within the expanded first operation part. For example, upon detecting an operation applied onto the first operation part via the touch screen, the mobile electronic device executes a process associated with the first operation part, and upon detecting an operation applied onto the second operation part, the mobile electronic device executes a process associated with the second operation part.

### CROSS-REFERENCE TO RELATED APPLICATIONS

This application is a Continuation of PCT international application Ser. No. PCT/JP2014/054751 filed on Feb. 26, 2014 which designates the United States, incorporated herein by reference, and which is based upon and claims the benefit of priority from Japanese Patent Applications No. 2013-37453 filed on Feb. 27, 2013, the entire contents of which are incorporated herein by reference.

### BACKGROUND OF THE INVENTION

1. Field of the Invention

The present application relates to a mobile electronic device, a method of control, and a storage medium.

2. Description of the Related Art

Mobile electronic device such as a mobile phone or smartphone includes a screen to display information corresponding to events of receiving emails, calls, or the like. Among these mobile electronic devices, for example, there is a mobile electronic device that displays information about receiving of emails or missed calls on a notification area provided at upper portions of screens displayed on their displays by using icons or the like. The notification area is often called as a status bar, for example.

### SUMMARY OF THE INVENTION

According to one aspect of the present disclosure, a mobile electronic device including a display module; and a control module, upon detecting an event, configured cause the display module to expand a first object associated with the event and display a second object indicating a detail of the event within the first object is provided.

According to another aspect of the present disclosure, a method of control performed by a mobile electronic device with a display module, the method including the steps of detecting an event; and expanding a first object associated with the detected event on the display module and displaying a second object indicating a detail of the event within the first object is provided.

According to another aspect of the present disclosure, a computer program product having computer instructions, stored on a non-transitory computer readable storage medium, for enabling a computer of a mobile electronic device with a display module executing the computer instructions to perform operations comprising: detecting an event; and expanding a first object associated with the detected event on the display module and displaying a second object indicating a detail of the event within the first object is provided.

### BRIEF DESCRIPTION OF DRAWINGS

FIG. 1 is a block diagram illustrating an example of a functional configuration of a smartphone according to an embodiment,

FIG. 2 is a diagram illustrating an example of a control to expand a first operation part and display a second operation part indicating a detail of an event within the first operation part,

FIG. 3 is a diagram illustrating an example of a control to perform a process associated with the operation part according to an operation applied thereto,

FIG. 4 is a diagram illustrating an example of a control to perform a process associated with the operation part according to an operation applied thereto,

FIG. 5 is a diagram illustrating an example of a control to cancel expanding the first operation part based on a detection result of a touch screen,

FIG. 6 is a diagram illustrating an example of a control to cancel expanding the first operation part based on a detection result of a touch screen,

FIG. 7 is a flow chart illustrating a flow of control on a smartphone according to an embodiment 1,

FIG. 8 is a diagram illustrating an example of a control to expand a first icon and display a second icon indicating a detail of an event within the first icon,

FIG. 9 is a diagram illustrating an example of a control to perform a process of an application associated with the icon according to an operation applied thereto,

FIG. 10 is a diagram illustrating an example of a control to perform a process of an application associated with the icon according to an operation applied thereto,

FIG. 11 is a diagram illustrating an example of a control to cancel expanding the first icon based on a detection result of a touch screen, and

FIG. 12 is a diagram illustrating an example of a control to cancel expanding the first icon based on a detection result of a touch screen.

### DETAILED DESCRIPTION OF EMBODIMENTS

Embodiments for implementing the present disclosure will be described in detail with reference to the drawings. Hereinafter, a smartphone will be described as an example of a mobile electronic device according to the present disclosure.

### Embodiment 1

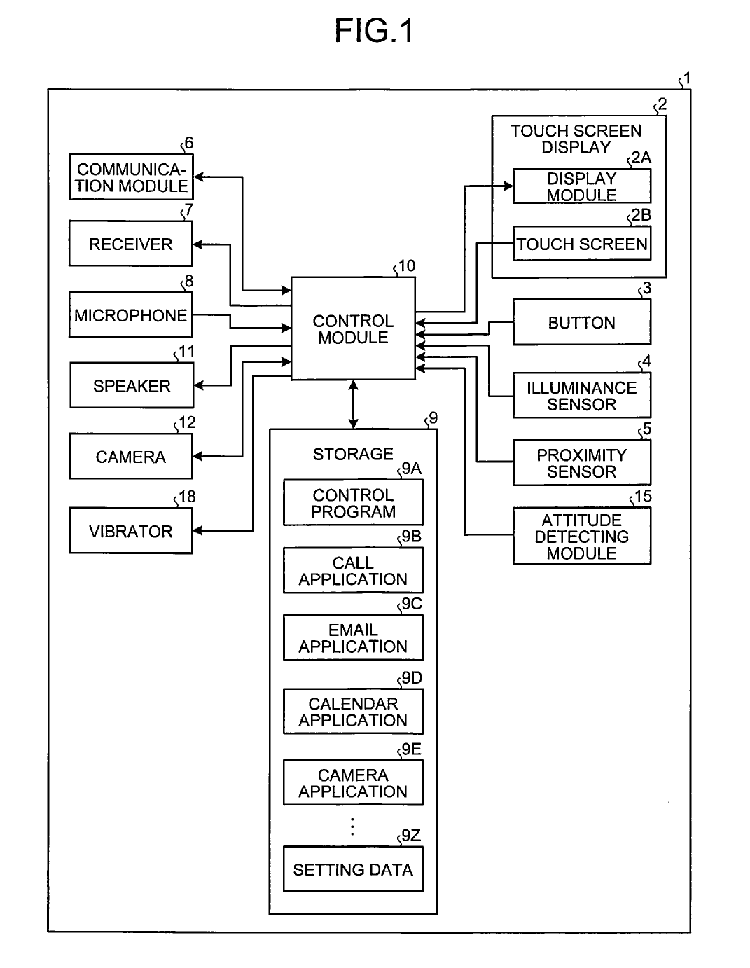

An example of a functional configuration of a smartphone 1 according to an embodiment is described. FIG. 1 is a block diagram illustrating the functional configuration of the smartphone according to the embodiment. Hereinafter, the same elements are denoted as an identical numerical number. Furthermore, repetitive description thereof may be omitted.

As illustrated in FIG. 1, the smartphone 1 includes a touch screen display 2, a button 3, an illuminance sensor 4, an proximity sensor 5, a communication module 6, a receiver 7, a microphone 8, a storage 9, a control module 10, a speaker 11, a camera 12, an attitude detecting module 15, and a vibrator 18.

The touch screen display 2 has a display module 2A and a touch screen 2B. The display module 2A and the touch screen 2B may be, for example, arranged with being overlapped, side by side, or apart from each other. If the display module 2A and the touch screen 2B are arranged with being overlapped, one or more sides of the display module 2A may not be along any sides of the touch screen 2B, for example.

The display module 2A includes a display device, such as a liquid crystal display (LCD), an organic electro-luminescence display (GELD), or an inorganic electro-luminescence display (IELD). The display module 2A displays characters, images, symbols, graphics, and the like. Screens including the characters, images, symbols, graphics, and the like displayed by the display module 2A include a screen called a lock screen, a screen called a home screen, and an application screen displayed during running of an application. The home screen is often called a desktop, a standby screen, an idle screen, a standard screen, an application list screen, or a launcher screen. In an embodiment 1, the display module 2A displays an operation part for a user to execute, with an operation thereon, a process associated with a particular communication partner. The operation part includes a first operation part associated with an event, such as reception of an email, a missed call, or a schedule notification, and a second operation part indicating a detail of the event. The first operation part is an example of a first object and the second operation part is an example of a second object.

The touch screen 2B detects contact between a finger, a pen, a stylus pen, or the like and the touch screen 2B. The touch screen 2B detects a position where a plurality of fingers, a pen, a stylus pen, or the like (hereinafter, simply referred to as “finger”) contacts with the touch screen 2B. The touch screen 2B transmits to the control module 10 the contact between the finger and the touch screen 2B (touch screen display 2), together with the position of the contacted spot on the touch screen display 2. In an embodiment 1, the touch screen 2B detects the contact to the operation part and transmits the detection to the control module 10, for example.

A detection type of the touch screen 2B may be any one from among a capacitive type, a resistive film type, a surface acoustic wave type (or an ultrasonic wave type), an infrared type, an electromagnetic induction type, a load detection type, and the like. Hereinafter, for the purpose of simple description, it is assumed that a user touches the touch screen 2B with his/her fingers in order to operate the smartphone 1.

The control module 10 (smartphone 1) identifies a type of a gesture, based on at least one of the contact detected by the touch screen 2B, the position where the contact is detected, a change in the position where the contact is detected, intervals at which contacts are detected, and the number of times the contacts are detected. The gesture is an operation applied onto the touch screen 2B (touch screen display 2) with the finger(s). Examples of the gesture identified via the touch screen 2B by the control module 10 (smartphone 1) include, but are not limited to, a touch, a long touch, a release, a swipe, a tap, a double tap, a long tap, a drag, a flick, a pinch-in, a pinch-out, etc. In an embodiment 1, the control module 10 (smartphone 1) identifies the gesture on the operation part via the touch screen 2B and executes a process or the like of an application associated with the operation part.

The button 3 receives inputs of an operation applied by the user. The button 3 may include one or more buttons.

The illuminance sensor 4 detects illuminance of ambient light of the smartphone 1. Illuminance indicates intensity, brightness, or luminance of light. The illuminance sensor 4 is used, for example, for adjustment of luminance of the display module 2A.

The proximity sensor 5 detects close objects without contacting thereto. The proximity sensor 5 detects the objects, based on a change in magnetic field, a change in returning time of a reflected ultrasonic wave, or the like. The proximity sensor 5 detects, for example, that the display module 2A has been brought into closer to a face. The illuminance sensor 4 and the proximity sensor 5 may be configured as a single sensor. The illuminance sensor 4 may be used as a proximity sensor.

The communication module 6 implements a wireless communication. Examples of wireless communication standards supported by the communication module 6 include, but are not limited to, communication standards for cellular phones of the 2G, 3G, 4G, and the like, short distance wireless communication standards, etc. Examples of the communication standards for cellular phones include, but are not limited to, Long Term Evolution (LTE), Wideband Code Division Multiple Access (W-CDMA), Worldwide Interoperability for Microwave Access (WiMAX), CDMA 2000, Personal Digital Cellular (PDC), Global System for Mobile Communications (GSM) (registered trademark), Personal Handy-phone System (PHS), etc. Examples of the short distance wireless communication standards include, but are not limited to, IEEE 802.11, Bluetooth (registered trademark), Infrared Data Association (IrDA), Near Field Communication (NFC), Wireless Personal Area Network (WPAN), etc. The WPAN communication standards include, for example, ZigBee (registered trademark). The communication module 6 may support one or more of the above mentioned communication standards.

The communication module 6 receives a radio signal of a predetermined frequency band from a GPS satellite, demodulates the received radio signal, and transmits the modulated signal to the control module 10. In the smartphone 1, the function of communicating with the GPS satellite may be separated from the communication module 6, and an individual communication module independent from the communication module 6 may be provided.

The receiver 7 is a sound output module. The receiver 7 outputs, for example, a sound signal transmitted from the control module 10. The receiver 7 is used for outputting voice of a person to whom the user talks over the phone, for example. The microphone 8 is a sound input module. The microphone 8 converts sound or the like of the user to a sound signal and transmits the sound signal to the control module 10.

The storage 9 stores therein programs and data. The storage 9 is also used as a work area where a result of process by the control module 10 is temporarily stored. The storage 9 may include any of non-transitory memory media, such as a semiconductor memory medium and a magnetic memory medium. The storage 9 may include various types of memory media. The storage 9 may include a combination of: a portable memory medium, such as a memory card, an optical disk, or a magneto-optical disk; and a device for reading out the memory medium. The storage 9 may include a storage device used as a temporary storage area, such as a random access memory (RAM).

The programs stored in the storage 9 include an application executed in the foreground or background, and a control program that supports operation of the application. For example, a screen of the application executed in the foreground is displayed on the display module 2A. The control program includes, for example, Operating System. The application and the control program may be installed in the storage 9, via wireless communication by the communication module 6 or via a non-transitory memory medium.

The storage 9 stores therein, for example, a control program 9A, a telephone call application 9B, a email application 9C, a calendar application 9D, a camera application 9E, setting data 9Z, and the like.

The control program 9A provides functions to control the smartphone 1 in a various manners. When an event, such as receiving an email, a missed call, a schedule notification, or the like, is detected, the control program 9A provides a function to expand the first operation part associated with the event on the display module 2A and display the second operation part indicating a detail of the event within the expanded first operation part. The first operation part is an example of the first object and the second operation part is an example of the second object.

Further, the control program 9A provides a function to execute a process associated with the first operation part when an operation applied onto the first operation part is detected via the touch screen 2B, and execute a process associated with the second operation part when an operation applied onto the second operation part is detected.

Furthermore, the control program 9A provides a function to execute a process for canceling expanding the first operation part based on a detection result of the touch screen 2B.

In addition, the control program 9A provides a function to establish communication employing Long Term Evolution (LTE), Wideband Code Division Multiple Access (W-CDMA), Worldwide Interoperability for Microwave Access (WiMAX), CDMA 2000, Personal Digital Cellular (PDC), Global System for Mobile Communications (GSM) (registered trademark), Personal Handy-phone System (PHS), and the like, and a function to establish short distance wireless communication employing IEEE 802.11, Bluetooth (registered trademark), Infrared Data Association (IrDA), Near Field Communication (NFC), Wireless Personal Area Network (WPAN), and the like through controlling the communication module 6 and the like. The control program 9A also provides a function to establish a telephone call through controlling the communication module 6, the microphone 8, and the like.

When a telephone call is established, the function provided by the control program 9A may be used in combination with a function provided by another program, such as the telephone call application 9B or the email application 9C stored in the storage 9. The functions provided by the control program 9A may be divided into program modules or may be combined with another program.

The telephone call application 9B provides a telephone call function for a telephone call via wireless communication. The email application 9C provides an email function to write, transmit, receive, and display the emails. The calendar application 9D provides a calendar function to manage a schedule. The camera application 9E provides a function to capture, edit, and manage picture images and moving picture images. These applications stored in the storage 9 are mere an example. As another example other than FIG. 1, a notepad application, a browser application, a navigation application, a music player application, a movie playback application, a calculator application, a tag application, and the like may be stored.

The setting data 9Z include information about various settings and processes associated with operation of the smartphone 1. The setting data 9Z include, for example, information about a process of an application associated with an operation part displayed on a home screen. By an operation applied onto the operation part, the smartphone 1 executes processes to display an email writing screen for the email to a particular destination, display an email received from the particular destination, display a new email writing screen for the new email to a particular destination, make a call to s particular phone number, or the like.

The control module 10 is a processing module. Examples of the processing module include, but are not limited to, a central processing module, a System-on-a-Chip (SoC), a micro control module, a field-programmable gate array (FPGA), etc. The control module 10 can achieve various functions by integrally controlling operation of the smartphone 1.

Specifically, the control module 10 executes instructions included in the programs stored in the storage 9 while referring the data stored in the storage 9, if necessary. The control module 10 controls functional modules according to the data and the instructions, and thus establishes the various functions. Examples of the functional modules include, but are not limited to, the display module 2A, the communication module 6, the microphone 8, the speaker 11, etc. The control module 10 may change the control according to a result of detection by a detector. Examples of the detector include, but are not limited to, the touch screen 2B, the button 3, the illuminance sensor 4, the proximity sensor 5, the microphone 8, the camera 12, the attitude detecting module 15, etc.

By executing the control program 9A, when an event, such as reception of an email, a missed call, or a schedule notice, is detected, the control module 10 executes a process to expand the first operation part associated with the event on the display module 2A and display the second operation part indicating a detail of the event within the expanded first operation part.

Further, by executing the control program 9A, the control module 10 executes a process associated with the first operation part when an operation applied onto the first operation part is detected via the touch screen 2B. The control module 10 executes a process associated with the second operation part when an operation applied onto the second operation part is detected.

Furthermore, by executing the control program 9A, the control module 10 executes a process for canceling expanding the first operation part based on a detection result of the touch screen 2B.

The speaker 11 is a sound output module. The speaker 11 outputs a sound signal transmitted from the control module 10 as a sound. The speaker 11 is used for outputting a ringtone and music, for example. One of the receiver 7 and the speaker 11 may also have a function of the other.

The camera 12 converts a captured image into an electric signal. The camera 12 includes, for example, an inside camera that captures an image of an object facing the display module 2A, and an outside camera that captures an image of an object facing an opposite side of the display module 2A.

The attitude detecting module 15 detects attitude of the smartphone 1. In order to detect the attitude, the attitude detecting module 15 includes at least one of an acceleration sensor, a direction sensor, and a gyroscope.

The vibrator 18 vibrates a part or all of the smartphone 1. In order to generate vibration, the vibrator 18 has, for example, a piezoelectric element, an eccentric motor, or the like. The vibration by the vibrator 18 is used to inform a user of various events, such as receiving a call.

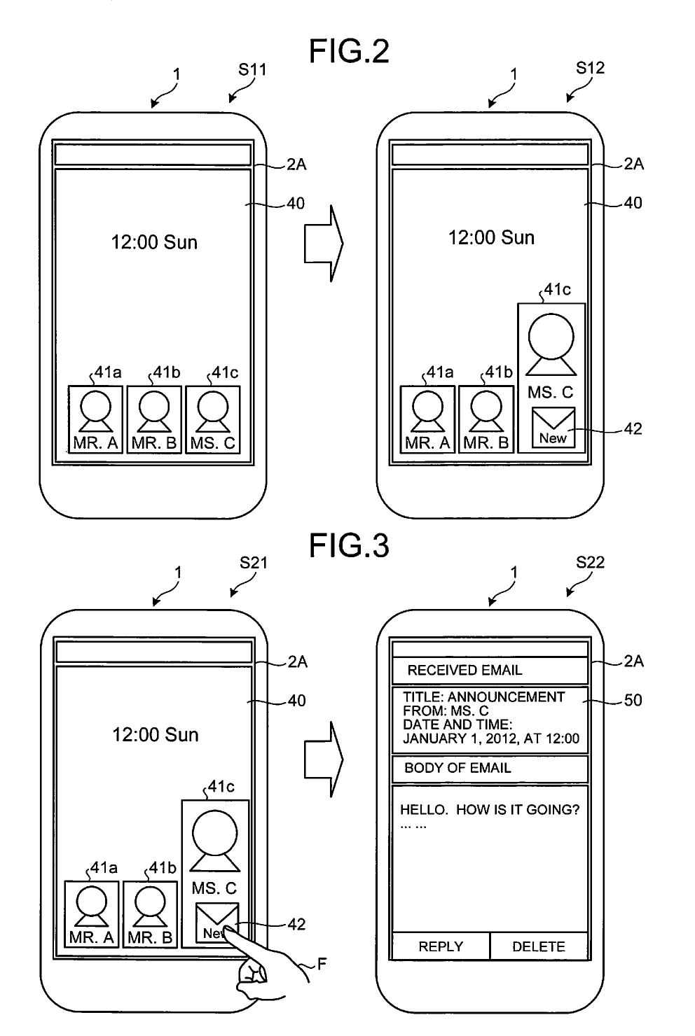

Next, with reference to FIG. 2 to FIG. 6, an example of control executed by the smartphone 1 according to an embodiment 1 is be described. Hereinafter, a finger (hand) of the user may be denoted as F.

FIG. 2 is a diagram illustrating an example of control of performing a function to expand the first operation part on the display module 2A and display the second operation part indicating a detail of an event within the first operation part.

As illustrated in FIG. 2, the smartphone 1 displays a home screen 40 on the display module 2A (Step S11). On the display module 2A, an operation part 41a, an operation part 41b, and an operation part 41c are displayed as the first operation part. For example, the operation part 41a is associated with a process for making a call to “Mr. A” as a process executed by an operation. For example, the operation part 41b is associated with a process for making a call to “Mr. B” as a process executed by an operation. For example, the operation part 41c is associated with a process for making a call to “Ms. C” as a process executed by an operation.

Subsequently, for example, when receiving an email from “Ms. C” (i.e., an electronic device owned by “Ms. C”), the smartphone 1 detects the reception as an event, can perform a function to expand the operation part 41c associated with the event, and display an operation part 42 indicating a detail of the event within the operation part 41c (Step S12). If the detected event is reception of an email from “Ms. C”, the operation part associated with the event becomes an operation part 41c corresponding to “Ms. C” and the second operation part indicating a detail of the event becomes an operation part 42 indicating reception of a newly received email.

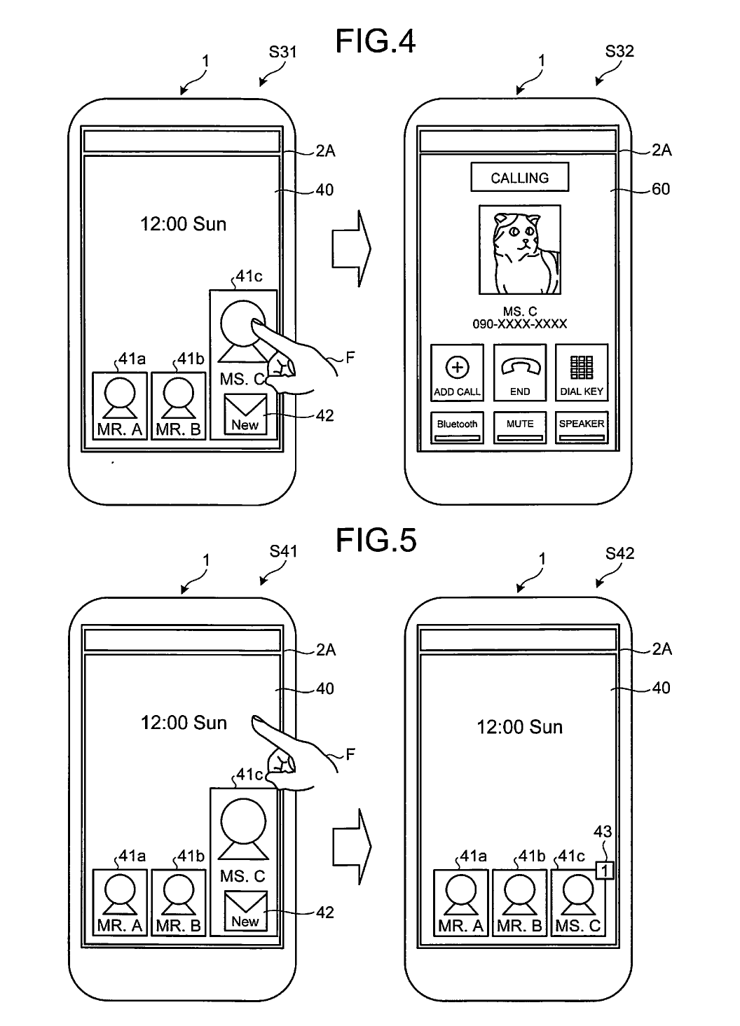

FIG. 3 and FIG. 4 are diagrams each illustrating an example of control of executing a process corresponding to according to an operation applied onto the operation part.

As illustrated in FIG. 3, when an operation applied onto the operation part 42 is detected via the touch screen 2B (Step S21), the smartphone 1 can display a screen 50 indicating a detail of a newly received email on the display module 2A (Step S22). Although FIG. 3 illustrates an example of displaying the detail of the newly received email, a list of emails rest on an email inbox may be displayed, for example.

As illustrated in FIG. 4, if an operation applied onto the operation part 41c is detected via the touch screen 2B (Step S31), the smartphone 1 can execute a process for making a call to “Ms. C” and display a making a call screen 60 on the display module 2A (Step S32). FIG. 4 illustrates an example in which a process for making a call to “Ms. C” has been associated with the operation part 41c in advance. If a process for writing an email has been associated with the operation part 41c, the process for writing the email can be executed.

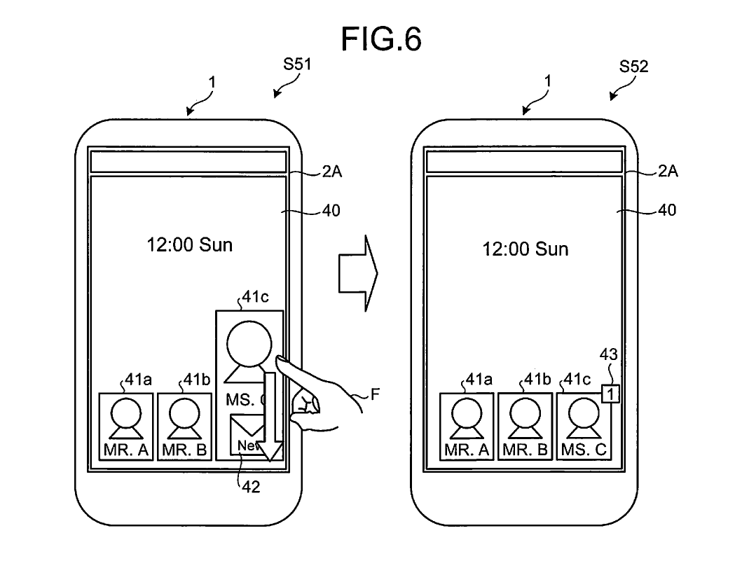

FIGS. 5 and 6 are diagrams each illustrating an example of control of canceling expanding the first operation part based on a detection result of the touch screen 2B.

As illustrated in FIG. 5, if the smartphone 1 detects an operation applied onto an area other than areas where the operation parts 41a to 41c and the operation part 42 are displayed among areas on the home screen 40 displayed on the display module 2A via the touch screen 2B (Step S41), the smartphone 1 can cancel expanding the operation part 41c and can display the operation part 41c in the original size (see Step S11 of FIG. 2) (Step S42). At Step S42, as shown in FIG. 5, the smartphone 1 may display a number image 43 indicating emails newly received from “Ms. C” on the operation part 41c. The number image 43 may correspond to the number of newly received emails. The embodiments are not limited to the number image 43, and the number image 43 may be of an alphabetic character, a symbol, a graphic, or the like. The smartphone 1 can eliminate the number image 43 after the newly received email has been read.

As shown in FIG. 6, when the smartphone 1 detects that a predetermined gesture is applied onto the expanded an operation part 41c via the touch screen 2B (Step S51), the smartphone 1 cancels expanding the operation part 41c and displays the operation part 41c in the original size (see Step S11 of FIG. 2) (Step S52). The predetermined gesture applied onto the operation part 41c corresponds to for example downward movement of a finger(s) on the home screen 40, which is called a swipe, a flick, or the like. The predetermined gesture is not limited to the swipe or flick, and may be a long touch, or the like. The downward direction on the home screen 40 corresponds to a vertical direction of characters displayed on the home screen 40.

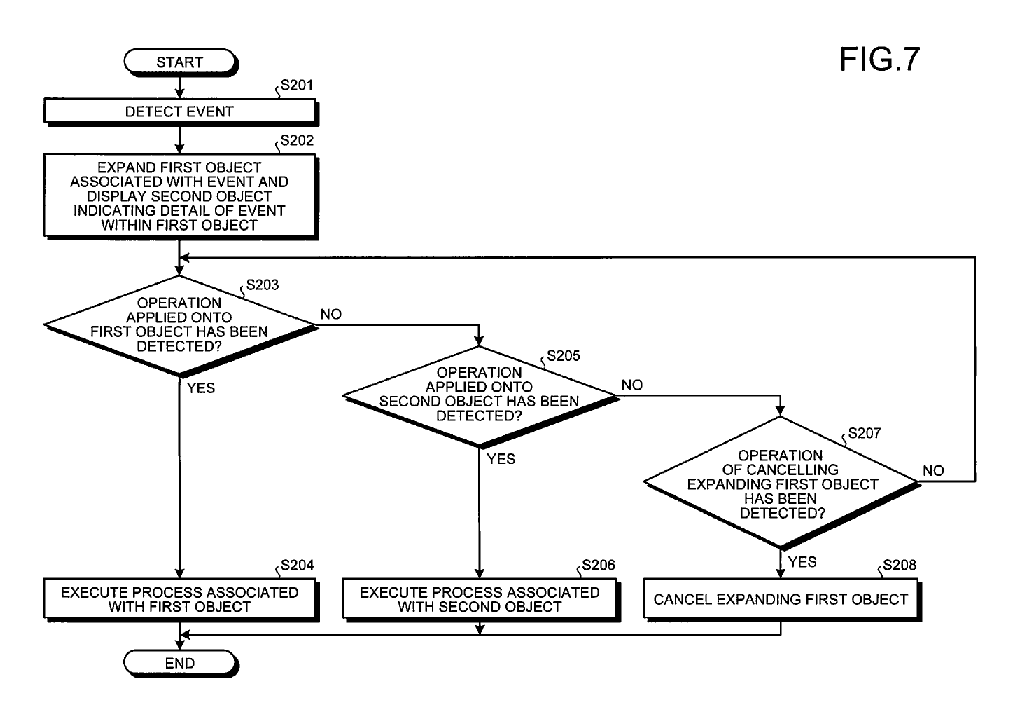

Next, by using FIG. 7, a flow of control performed by the smartphone 1 according to an embodiment 1 will be described. FIG. 7 is a flow chart illustrating the flow of control by the smartphone 1 according to an embodiment 1. The control module 10 loads the control program 9A from the storage 9 and then executes it, and thus the control illustrated in FIG. 7 is achieved.

As illustrated in FIG. 7, when an event is detected (Step S201), the control module 10 can perform a function to expand a first object on the display module 2A (the first operation part 41c or the like) associated to the event and display a second object (the second operation part 42 or the like) indicating a detail of the event within the first object (Step S202). In an embodiment 1, the event corresponds to receiving emails, missed calls, a schedule notification, or the like.

Subsequently, the control module 10 determines whether an operation applied onto the first object has been detected (Step S203).

As a result of the determination, if an operation applied onto the first object has been detected (Yes at Step S203), the control module 10 can execute a process associated with the first object (Step S204) and terminates the control illustrated in FIG. 7. In an embodiment 1, the process associated with the first object corresponds to, for example, making a call, writing an email, or the like.

On the other hand, as a result of the determination, if an operation applied onto the first object has not been detected (No at Step S203), the control module 10 determines whether an operation applied onto the second object has been detected (Step S205).

As a result of the determination, if an operation applied onto the second object has been detected (Yes at Step S205), the control module 10 can execute a process associated with the second object (Step S206) and terminates the control illustrated in FIG. 7. In an embodiment 1, the process associated with the second object corresponds to, for example, display of newly received emails, or the like.

On the other hand, as a result of the determination, if an operation applied onto the second object has not been detected (No at Step S205), the control module 10 determines whether an operation of canceling expanding the first object has been detected (Step S207).

As a result of the determination, if the operation of canceling expanding the first object has been detected (Yes at Step S207), the control module 10 can cancel expanding the first object (Step S208) and terminates the control illustrated in FIG. 7.

On the other hand, as a result of the determination, if the operation of canceling expanding the first object has not been detected (No at Step S207), the control module 10 returns to the above described Step S203.

As described above, in an embodiment 1, when an event such as receiving emails, a missed call, or a schedule notification is detected, the smartphone 1 can execute a process of performing a function to expand the first operation part associated with the event on the display module 2A, and display the second operation part indicating a detail of the event within the expanded first operation part. Therefore, according to an embodiment 1, it results in a display easy to see event information such as receiving emails or a missed call.

In an embodiment 1, the smartphone 1 can execute a process associated with an operation part upon applying an operation onto the operation part. Therefore, according to an embodiment 1, it results in a display easy to see event information such as receiving emails or missed calls while simply executing a process according to an event such as receiving emails or missed calls. Consequently, user-operability is improved.

In an embodiment 1, the smartphone 1 can cancel expanding the operation part based on a result of detection by the touch screen 2B. Therefore, according to an embodiment 1, it results in a display easy to see event information while freely modifying it depending on the user's interest.

In an embodiment 1, according to an operation by a user, the smartphone 1 may perform a function to further expand the operation part being expanded or a function to shrink it. The smartphone 1 performs a function to expand the operation part according to a pinched-out distance when the smartphone 1 detects a gesture of pinching out the operation part being expanded. The smartphone 1 can perform a function to shrink the operation part according to a pinched-in distance when the smartphone 1 detects a gesture of pinching in the operation part being expanded.

### Embodiment 2

In the above described embodiment 1, the control has been described for a case where the operation parts (41a to 41c, 42, and the like) for executing by user's operation a process associated with a particular person with whom a user communicates are displayed on the home screen 40. In an embodiment 2, control for a case where icons corresponding to various applications are displayed on the home screen 40 is described below.

A functional configuration of the smartphone 1 according to an embodiment 2 is basically identical to the functional configuration described in an embodiment 1, except for some points described below.

In an embodiment 2, the display module 2A displays icons to execute processes of applications by user's operation. The icons include a first icon associated with an event such as receiving emails, missed calls, or a schedule notification, and a second icon indicating a detail of the event. The first icon is an example of the first object and the second icon is an example of the second object.

In an embodiment 2, the touch screen 2B detects contact to the icon and transmits it to the control module 10.

In an embodiment 2, the control module 10 (smartphone 1) identifies a gesture applied onto the icon via the touch screen 2B and executes a process of an application associated with the icon.

When an event such as receiving emails, missed calls, or a schedule notification is detected, the control program 9A can provide a function to execute a process to expand a first icon associated with the event on the display module 2A and display a second icon indicating a detail of the event within the expanded first icon. Furthermore, by executing the control program 9A, the control module 10 can execute a process of an application associated with the first icon upon detecting an operation applied onto the first icon via the touch screen 2B. Also, the control module 10 can execute a process of an application associated with the second icon upon detecting an operation applied onto the second icon. Furthermore, by executing the control program 9A, the control module 10 can execute a process of canceling expanding the first icon based on a detection result of the touch screen 2B.

By executing the control program 9A, when an event such as receiving emails, missed calls, a schedule notification, or the like is detected, the control module 10 can execute a process to expand the first icon associated with the event on the display module 2A, and display the second icon indicating a detail of the event within the expanded first icon. Furthermore, by executing the control program 9A, when an operation applied onto the first icon is detected via the touch screen 2B, the control module 10 can execute a process of an application associated with first icon. When an operation applied onto the second icon is detected, the control module 10 executes a process of an application associated with the second icon. Furthermore, by executing the control program 9A, the controller 10 executes a process of canceling expanding the first icon based on a detection result of the touch screen 2B.

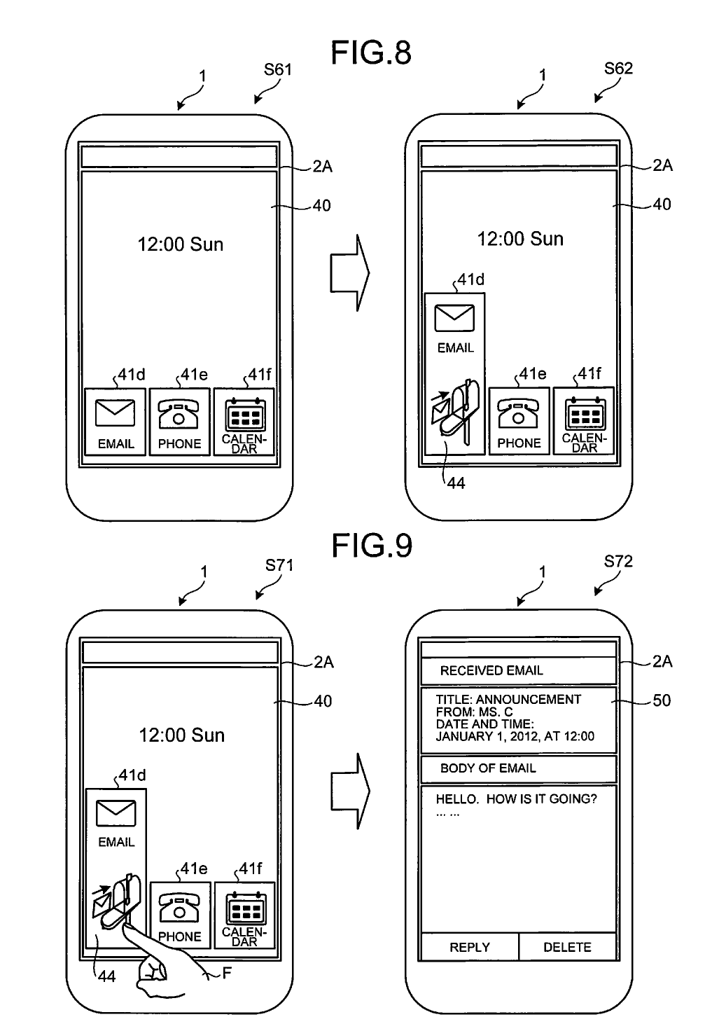

With reference to FIGS. 8 to 12, an example of control executed by the smartphone 1 according to an embodiment 2 is described below.

FIG. 8 is a diagram illustrating an example of control of a function to expand the first icon on the display module 2A and display the second icon indicating a detail of an event within the first icon.

As illustrated in FIG. 8, the smartphone 1 displays the home screen 40 on the display module 2A (Step S61). On the display module 2A, a first icon 41d, a first icon 41e, and a first icon 41f are displayed as the first icon. The first icon 41d is previously associated with a process of the email application 9C executable by an operation, for example. The first icon 41e is previously associated with a process of the call application 9B executable by an operation, for example. The first icon 41f is previously associated with a process of the calendar application 9D executable by an operation, for example.

Subsequently, for example, upon receiving an email, the smartphone 1 detects it as an event, and can perform a function to expand the first icon 41d associated with the event and display a second icon 44 indicating a detail of the event within the first icon 41d (Step S62). If the detected event is a missed call, the first icon associated with the event becomes the icon 41e. If the detected event is a schedule notification, the first icon associated with the event becomes the icon 41f.

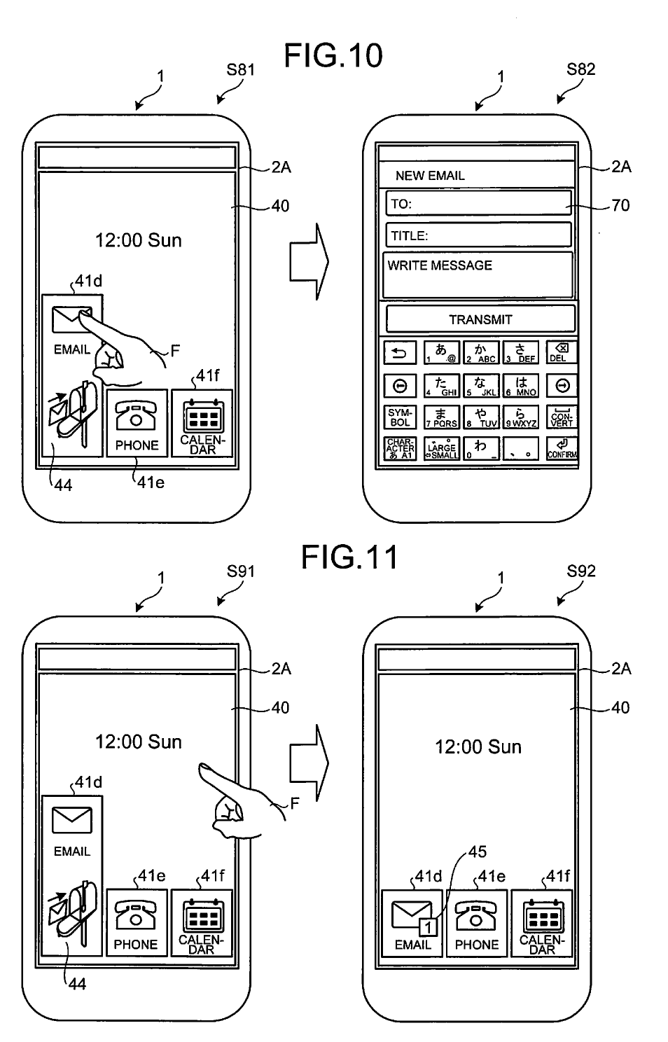

FIGS. 9 and 10 are diagrams, each illustrating an example of control of executing a process of an application associated with an icon according to an operation applied onto the icon.

As illustrated in FIG. 9, upon detecting an operation applied onto the icon 44 via the touch screen 2B (Step S71), the smartphone 1 displays on the display module 2A the screen 50 indicating a detail of newly receiving emails (Step S72). FIG. 9 shows an example of displaying the detail of the newly receiving emails, but it is also possible to display a list of emails rest on an inbox, for example.

As illustrated in FIG. 10, when an operation applied onto the icon 41d is detected via the touch screen 2B (Step S81), the smartphone 1 boots the mail application 9C and displays a screen 70 for writing an email on the display module 2A (Step S82). At Step S82, an example of displaying the screen 70 for writing an email is shown, but the embodiments are not limited thereto. An email box screen may be displayed.

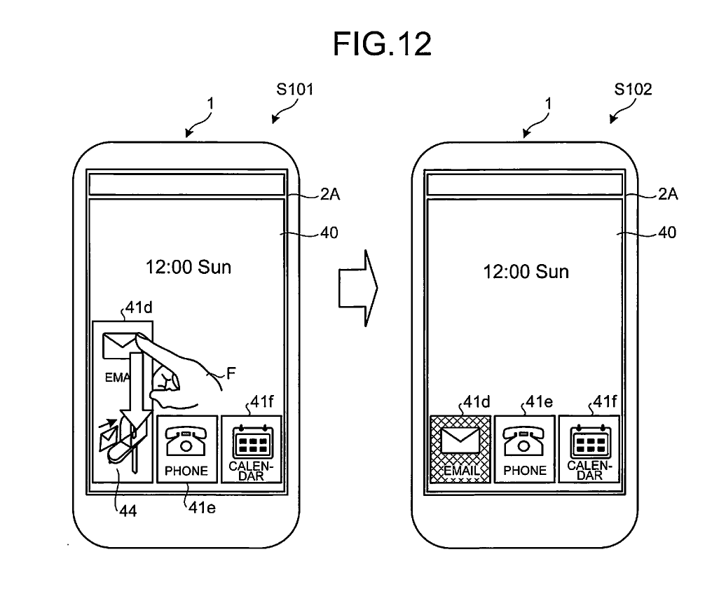

FIGS. 11 and 12 are diagrams, each illustrating an example of control of canceling expanding the first icon based on a detection result of the touch screen 2B.

As illustrated in FIG. 11, upon detecting an operation applied onto an area other than areas where the icons 41d to 41f and icon 44 are displayed on the home screen 40 on the display module 2A via the touch screen 2B (Step S91), the smartphone 1 can cancel expanding the icon 41d and can display the icon 41d in the original size (see Step S61 of FIG. 8) (Step S92). As illustrated in FIG. 11, at Step S92, the smartphone 1 may display on the icon 41d a number image 45 indicating newly receiving emails. The number image 45 may correspond to the number of newly received emails. An embodiment is not limited to the number image 45. The image 45 may be of an alphabetic character, a symbol, a graphic, or the like. The smartphone 1 can delete the number image 45 after reading the newly received emails.

As illustrated in FIG. 12, upon detecting a predetermined gesture applied onto the expanded icon 41d via the touch screen 2B (Step S101), the smartphone 1 can cancel expanding the icon 41d and can display the icon 41d in the original size (see Step S61 of FIG. 8) (Step S102). The predetermined gesture applied onto the icon 41d is downward movement of a finger(s) on the home screen 40, which corresponds to a swipe, a flick, or the like. The predetermined gesture is not limited to the swipe or flick, and may be a long touch, or the like. The downward direction on the home screen 40 corresponds to a vertical direction of characters displayed on the home screen 40. As illustrated in FIG. 12, at Step S102, the smartphone 1 may change a background color of the icon 41d to indicate newly receiving emails.

In the above described embodiments, although a smartphone has been described as an example of a device according to the claims appended hereto, the device according to the appended claims is not limited to a smartphone. The device according to the appended claims may be a mobile electronic device other than a smartphone. Examples of the mobile electronic device include, but are not limited to, a mobile phone, a tablet, a mobile personal computer, a digital camera, a media player, an electronic book reader, a navigator, a game machine, etc.

In order to completely and clearly disclose the techniques according to the appended claims, characteristic embodiments have been described. However, the appended claims are not to be limited to the above described embodiments, and are to be realized with all modifications and substitutable configurations that can be invented by those skilled in the art within the scope of the basic matter disclosed in this specification.

Therefore, a mobile electronic device, a control method, and a storage medium, which can allow for an easy-to-see display of event information about receiving emails or missed calls to a user, can be achieved.

What is claimed is:

1. A mobile electronic device comprising:
a display module; and
a control module, upon detecting an event, configured to cause the display module to expand a first object associated with the event and display a second object indicating a detail of the event within the first object.

2. The mobile electronic device according to claim 1, wherein
the control module executes a process associated with the first object when an operation is applied onto the first object, and
the control module executes a process associated with the second object when an operation is applied onto the second object.

3. The mobile electronic device according to claim 2, wherein the control module cancels expanding the first object upon detecting an operation applied onto an area among display areas, which is other than areas where the first object and the second object are being displayed.

4. The mobile electronic device according to claim 2, wherein the control module cancels expanding the first object upon detecting a predetermined touch gesture.

5. A method of control performed by a mobile electronic device with a display module, the method comprising the steps of:
detecting an event; and
expanding a first object associated with the detected event on the display module and displaying a second object indicating a detail of the event within the first object.

6. A computer program product having computer instructions, stored on a non-transitory computer readable storage medium, for enabling a computer of a mobile electronic device with a display module executing the computer instructions to perform operations comprising:
detecting an event; and
expanding a first object associated with the detected event on the display module and displaying a second object indicating a detail of the event within the first object.
